(19) United States
(12) Patent Application Publication
(10) Pub. No.: US 2023/0256553 A1
(43) Pub. Date: Aug. 17, 2023

(54) MACHINE DOOR AND MACHINE

(71) Applicant: JAGER ENGINEERING GMBH, Koenigsfeld (DE)

(72) Inventors: Markus KLOKER, Altheim (DE); Hubert JAEGER, Koenigsfeld (DE)

(21) Appl. No.: 18/012,326

(22) PCT Filed: Jun. 22, 2021
(86) PCT No.: PCT/EP2021/067008

§ 371 Date: Dec. 22, 2022

(30) Foreign Application Priority Data
Jun. 24, 2020 (DE) 10 2020 116 649.4

(51) Int. Cl. B23Q 11/08; G05B 13/02

(52) U.S. Cl. CPC B23Q 11/0891; G05B 13/0205

(57) ABSTRACT

The present invention relates to a machine door (2), comprising a door frame (10) having an opening (20), at least three door segments (30), and an actuating means (40), wherein the actuating means (40) can adjust the at least three door segments (30) from a position in the door frame (10) that clears the opening (20) to a position out of the door frame (10) that closes the opening (20). In addition, the present invention relates to a machine (1) having such a machine door (2).

The present invention relates to a machine door having the features of claim 1 and to a machine having the features of claim 14.

Machine doors are previously known from the prior art in different designs. Machine doors are used to secure access to a process chamber of a machine, for example a lathe, a milling machine, a grinding machine, or other machines for processing workpieces, and form part of safety-relevant machine cladding. Machine doors can be provided with mechanical and/or electrical safety devices, which are intended to ensure that the machine door is properly closed during the process in the process chamber and that the machine door remains closed until the process is completed or interrupted.

A large number of machine doors that can be opened automatically are already known from the prior art and are held movably either by means of a rail guide or by means of hinges in order to enable access to the process chamber. It has been demonstrated that a disadvantage of such a machine door is that the guides, hinges, seals, or door limit switches fail prematurely.

For the automation of machines, in particular for the subsequent automation of existing machines, workpieces can be introduced into the process chamber of the machine by means of a robot or a handling unit. In addition to the enormous effort, it has been demonstrated that opening and closing the machine door in particular results in delays in the automated loading of the workpieces by means of the robot or the handling unit.

This is where the present invention begins.

The object of the present invention is to propose an improved machine door which eliminates the disadvantages known from the prior art in an expedient manner and enables rapid and automated opening and closing. The machine door should be able to be opened and closed fully automatically, to be retrofitted to existing machine tools, and to leave clear a sufficiently sized access point to the process chamber.

These objects are achieved by a machine door having the features of claim 1 and by a machine having the features of claim 14.

Further advantageous embodiments of the present invention are specified in the dependent claims.

The machine door according to the invention having the features of claim 1 has a door frame with an opening, has at least three door segments, and has at least one actuating means. Here and in the following, a door segment is to be understood as meaning an isolated portion of a door which, together with the at least two other door segments, is configured to fully close the opening in the door frame, which also forms the opening of a machine. According to the invention, the actuating means is configured to adjust the at least three door segments from a position in the door frame that clears the opening to a position out of the door frame that closes the opening. In the position in which the at least three door segments clear the opening, the at least three door segments leave the opening in the door frame completely clear. To close the opening in the door frame, the at least three door segments are moved toward one another by the actuating means in a plane of the door frame, after which each of the at least three door segments is moved along a path, and the paths meet in the center of the opening or around the center of the opening. The plane is preferably parallel to a front side of the door frame. In the position that clears the opening, the at least three door segments are preferably completely accommodated in the door frame, and in the position that closes the opening, the at least three door segments are closed by the actuating means in a layered manner like that of an optical shutter.

In addition, it has proven to be advantageous if the fastening means can adjust the at least three door segments synchronously in a dipping movement. The dipping movement can be described approximately as a movement along a curved line, the curved lines meeting approximately at the center of the opening in the door frame. Such a movement corresponds to a helical movement around the center of the opening.

According to a preferred development of the present invention, in the position that clears the opening the at least three door segments are arranged within a recess in the door frame. The recess in the door frame is configured in such a way that neither human limbs nor other foreign objects can collide with the door segments in the recess.

Furthermore, it has proven to be advantageous if the opening in the door frame is of circular design. In this preferred embodiment, the opening in the door frame is formed around an axis, with each door segment being moved in a helical movement toward the axis when closing the opening or vice versa when opening.

In addition, it has proven to be advantageous if in the position which closes the opening the at least three door segments overlap in a center of the opening, preferably in the axis.

Furthermore, it has proven to be advantageous if the at least three door segments are arranged circumferentially symmetrically around the opening. In a preferred development of the present invention, more than three door segments, preferably six, nine, twelve, fifteen door segments or more can be provided. It should be noted at this point that the number of door segments must be at least three and can otherwise be selected as desired.

According to a further advantageous embodiment of the present invention, each door segment is dagger-shaped. In particular, it is preferred if each door segment resembles a curved dagger shape, with the tip of the door segment being rounded and having the shape of a partial circle or semicircle, for example.

In addition, it has proven to be advantageous if the actuating means comprises a synchronizing means which can be rotated about the opening and by means of which the at least three door segments are connected to one another. The synchronizing means which can be rotated about the opening can be, for example, a synchronizing ring or part of a synchronizing ring, and can be coupled to each door segment by suitable means in order to move each door segment from the position within the door frame that clears the opening to the position that closes the opening.

The synchronizing means or the synchronizing ring is preferably form-fittingly held by at least one rotary bearing, it preferably being possible for the at least one rotary bearing to be arranged on the side facing away from the opening in the door frame. The synchronizing means and the at least one rotary bearing can engage with one another, which results in a form fit in a radial direction, but also a form fit in the axial directions.

The rotary bearing can preferably comprise a plain bearing, a ball bearing, and/or roller bearing. Furthermore, a plurality of rotary bearings can preferably be arranged around the opening, in particular circumferentially symmetrically, in order to keep the synchronizing means or the synchronizing ring mounted in a supported manner.

Each door segment is preferably pivotally connected to the actuating means, it being possible for the rotary joint to be selected, for example, by a shoulder screw and a sliding means arranged between the shoulder screw and the door segment and/or the actuating means. The sliding means can be a plastic sleeve, a metal sleeve, a ball or roller bearing, or the like.

Furthermore, it has proven to be advantageous if each door segment is connected to the door frame in the manner of a coupler of a linkage mechanism. A coupler or a coupling element is understood to mean a linkage mechanism element which is not directly connected to the door frame.

The coupler or the coupling element and the associated door segment do not follow a movement about a single pole or axis, but around instantaneous centers of rotation. Each door segment can also be connected to the coupling element, it being possible for the door segment and the coupling element to be connected by a form-fitting, frictional, and/or integral connection.

According to a preferred development of the present invention, the coupling element can be made of a metallic material, while each door segment can be made of another, preferably high-strength, material. For example, the at least three door segments can be made of a multi-component material or a composite material, for example a carbon fiber composite material. By specifically selecting the materials used for the at least three door segments, the door segments can be resistant to mechanical effects and, for example, be shot-proof in order to meet particularly high security requirements.

According to a preferred development of the present invention, each door segment is connected to the door frame via a linkage mechanism element. The linkage mechanism element is pivotally connected at one end to the door frame and at the other end to the relevant door segment. The door segment or the coupling element with the door segment is in turn pivotally arranged between the linkage mechanism element and the actuating means or the synchronizing means or the synchronizing ring; the pivoted connection between the actuating means or the synchronizing means or the synchronizing ring and the pivoted connection to the linkage mechanism element are mutually spaced.

Furthermore, it has proven to be advantageous if the actuating means has a drive, the at least one drive preferably being a linear drive. In a preferred development, the at least one drive can comprise a pneumatic cylinder that is characterized by high dynamics. Alternatively, the at least one drive can comprise a rotary drive which acts in particular by means of a gear. Such a drive can comprise, for example, a single-stage or multi-stage toothed gear, a worm gear, a planetary gear, and/or a multi-pole, electric direct drive, also known as a torque drive. A plurality of drives can preferably be arranged around the opening, in particular circumferentially symmetrically. Each drive can be connected to the synchronizing means or synchronizing ring via a lever, the lever preferably being L-shaped in order to at least partly encompass a door segment or the coupler and/or the linkage mechanism element, as a result of which a particularly flat design can be realized.

Furthermore, it can be advantageous if a sensor system is provided which can detect whether the opening in the door frame is in the cleared or closed position. For example, it can be advantageous if the position of the synchronizing means or synchronizing ring and/or the at least one drive can be detected. Furthermore, a presence detector can also be provided, by means of which objects or people can be detected in a danger area adjacent to the door frame.

The machine door can also have an interface that makes it possible to communicate with the machine. In particular, safety-relevant data can be exchanged, which ensures that the opening in the machine door cannot be opened during a process or that the process in the machine is interrupted when the opening is cleared. Appropriate connections for transferring media can also be provided in the interface, for example compressed air, hydraulic oil, or electrical energy, in order to supply the at least one drive with energy from the machine.

A further aspect of the present invention relates to a machine having a process space and having a machine door as described above.

An exemplary embodiment of the present invention is described in detail below with reference to the accompanying drawings. In the drawings:

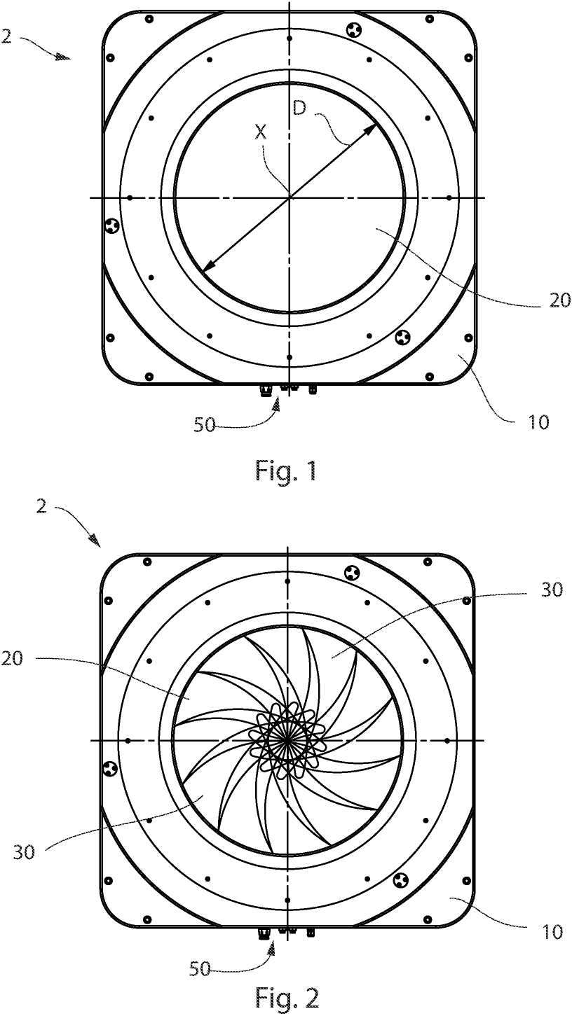

FIG. 1 shows a schematic and simplified plan view of a machine door according to the invention with a door frame and an opening in the open state;

FIG. 2 shows a schematic and simplified plan view of the machine door according to FIG. 1, the opening in the door frame being closed jointly by a plurality of door segments;

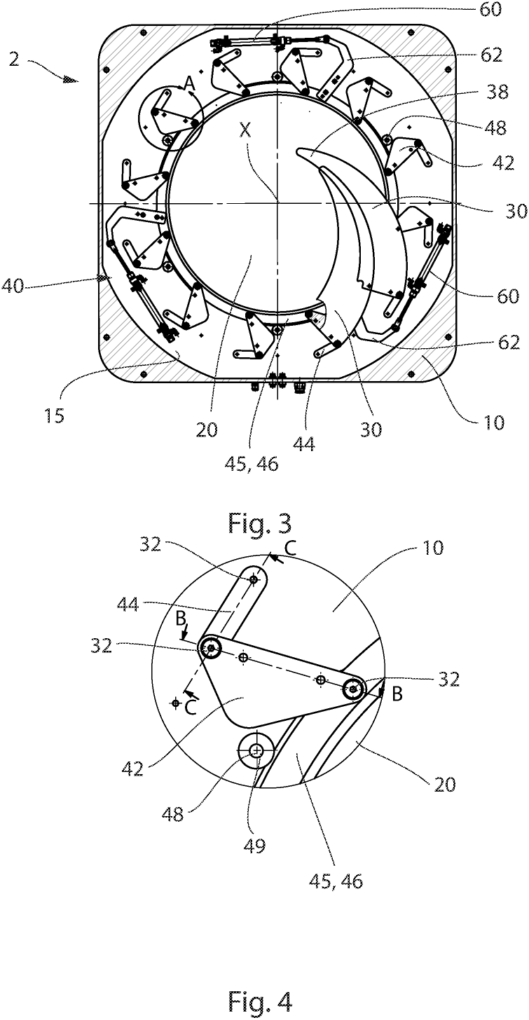

FIG. 3 is a partially sectional and simplified view of the machine door according to FIGS. 1 and 2, with actuating means being visible, by means of which the door segments can be moved between a position that clears the opening and a position that closes the opening;

FIG. 4 is an enlarged view of the actuating means according to detail A in FIG. 3;

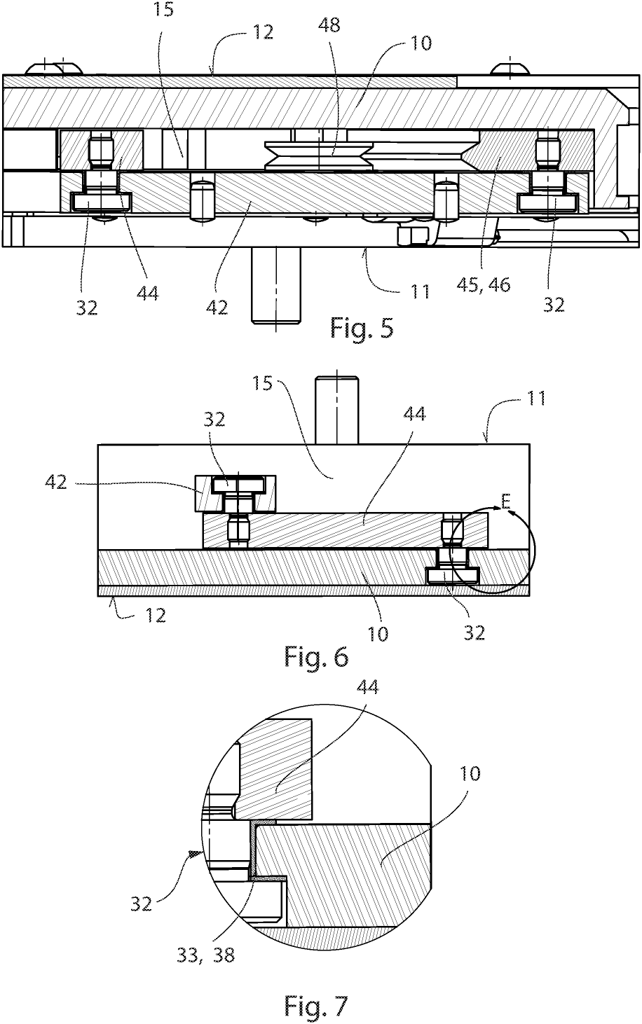

FIG. 5 is a sectional view along the section line B-B in FIG. 4;

FIG. 6 is a sectional view along the section line C-C in FIG. 4; and

FIG. 7 is an enlarged detail view of a rotary bearing according to detail E in FIG. 6.

Identical or functionally identical parts or components are identified below with the same reference symbols. For the sake of clarity, not all parts that are the same or functionally the same are provided with a reference number in the individual figures.

FIG. 1 shows a plan view of a machine door 2, which can be arranged in a wall in the region of an access to a process chamber of a machine 1 (not shown).

The machine door 2 has a door frame 10 which extends around an opening 20. The machine door 2 can be connected directly to the wall of the machine 1 and fully close the access point to the process chamber of the machine 1.

The door frame 10 has a front side 11 and a rear side 12 (hidden), the front side 11 being located on the side of the machine door 2 facing away from the process chamber and the rear side 12 on the side of the machine door facing the process chamber.

The opening 20 connects the front side 11 to the rear side 12 and can be circular about an axis X, as in the illustrated and described exemplary embodiment, the opening 20 having a diameter D. The diameter D is preferably 300 mm < D < 1000 mm.

In addition, the machine door 2 has a plurality of door segments 30, which can be advanced by an actuating means 40 from a position in the door frame 10 that clears the opening 20 according to FIG. 1 to a position out of the door frame 10 that closes the opening 20 according to FIG. 2. In the exemplary embodiment shown, the machine door 2 has twelve door segments 30 which are of identical design and are arranged circumferentially symmetrically about the X axis.

The door segments 30 are fully retracted by the actuating means 40 in the position that clears the opening 20 into a recess 15 in the door frame 10, which recess is shown in FIG. 3. To close the opening 20, the door segments 30 are advanced out of the recess 15 toward the axis X in a helical movement until the opening 20 is fully closed. In this position, a free end 38 of each door segment 30 protrudes beyond the axis X and the free ends 36 of the door segments 30 overlap — as can be seen from FIG. 2 - in the center of the opening 20.

Each door segment 30 can have the shape of a curved dagger and have a circular rounded portion at the free end 38. The door segments 30 can also be made from any desired material, for example from a metallic material or from a plastic, with multi-component materials or composite materials, in particular carbon fiber composite materials, preferably being used.

With reference to FIGS. 3 to 7 it can be seen that the actuating means 40 comprises a synchronizing means 45 and at least one drive 60. The drive 60 is coupled to the door segments 30 by means of the synchronizing means 45.

In the exemplary embodiment shown, the synchronizing means 45 is designed as a synchronizing ring 46 which is kept mounted in a supported manner around the opening 20 coaxially with the axis X in the recess 15 in the door frame 10 both axially and radially by a rotary bearing 48. In the exemplary embodiment described, the synchronizing means 45 is supported by a plurality of rotary bearings 48 which are distributed around the circumference and can comprise a roller bearing or a roller ball bearing. In order to mount the synchronizing means 45 with as little play as possible, the rotary bearings 48 can be positioned in the recess 15 or on the door frame 10 by means of an eccentric 49.

The rotary bearing 48 can be configured to encompass the synchronizing ring 46 both on the side facing the front side 11 and on the side facing the rear side 12. The synchronizing ring 46 has a shape corresponding to the rotary bearing 48 on the side facing the rotary bearing 48.

The forcibly guided movement of the door segments 30 by means of the actuating means 40 can take place in the manner of a linkage mechanism. For this purpose, the actuating means 40 comprises, in addition to the synchronizing means 45 and the drive 60, a coupler or a coupling element 42 and a linkage mechanism element 44 for each of the door segments 30. The linkage mechanism element 44 is rotatably connected to the door frame 10 by means of a rotary joint 32 as a “rocker” in relation to the axis X in a radial direction and connects the coupling element 42 to the door frame 10. The coupling element 42 is connected at one end (radially inside) to the synchronizing means 45 and at the other end (radially outside) to the door frame 10 via a linkage mechanism element 44. The door segment 30 is fastened to the coupling element 42. At this point it should be noted that the door segment 30 can be formed integrally with the coupling element 42 or can be connected to a coupling element 42. The coupling element 42 can preferably be connected to the door segment 30 by means of an integral connection and/or a screw connection.

Each coupling element 42 is coupled to the synchronizing means 45 and the linkage mechanism element 44 via a rotary joint 32. Furthermore, each linkage mechanism element 44 is connected to the door frame 10 via a further rotary joint 32.

The door segments 30 are designed and arranged in such a way that they overlap with adjacent door segments 30 both in the position that clears the opening 20 and in the position that closes the opening 20; see FIGS. 2 and 3. In a circumferential direction around the axis X, the door segments 30 can be in frictional contact with the adjacent door segment 30 both on the side facing the front side 11 and on the side facing the rear side 12.

In the position that closes the opening 20, the free ends 38 of the door segments 30 project beyond the center of the opening 20 into an opposite half of the opening. The overlap can preferably be up to 20% of the radius of the opening 20. Accordingly, a chord length of each door segment 30 is greater than the radius of the opening 20.

As can be seen from FIG. 3, the machine door 2 can have three drives 60 which are distributed circumferentially symmetrically around the opening 20. Each drive 60 can comprise a linear drive, in particular a pneumatic actuating cylinder.

The drive 60 can be arranged in the recess 15 in the door frame 10 and can be connected to the synchronizing means 45 by means of an L-shaped lever 62. The L-shaped lever 62 extends between two adjacent linkage mechanism elements 44 and coupling elements 42 and can encompass them at least partly. The drive 60 is arranged on the side of the coupling elements 42 and linkage mechanism elements 44 facing away from the opening 20, as a result of which a particularly compact design can be realized.

As can be seen with reference to FIGS. 6 and 7, the rotary joints 32 can comprise a shoulder screw which is rotatably coupled to the relevant component by means of a sleeve as a sliding means 33.

An advance movement of the drives 60 leads to a synchronous movement of the door segments 30. Each door segment 30 can be advanced in a helical movement about the axis X, with the door segments 30 being advanced toward one another in the direction of the axis X in a plane of the door frame 10 to close the opening 20 and retreat fully into the recess 15 to clear the opening 20. During the advance movement by the actuating means 40, each door segment 30 undergoes a rotary movement about instantaneous centers of rotation in the helical movement.

The machine door 2 can have a sensor system (not shown) which makes closure detection possible. The sensor system can detect the position of the door segments 30 and/or the position of the actuating means 40. Furthermore, the sensor system can have a proximity sensor or a presence detector for monitoring the danger area of the machine door 2.

Through an interface 50 of the machine door 2, electrical signals and electrical energy can be exchanged between the machine 1 and the machine door 2, but also media such as compressed air or hydraulic oil. In particular, the interface enables communication between a machine controller of the machine 1 and the machine door 2.

List of Reference Numerals

| | |
|---|---|
| 1 | machine |
| 2 | machine door |
| 10 | door frame |
| 11 | front side |
| 12 | rear side |
| 15 | recess |
| 20 | opening |
| 30 | door segment |
| 32 | rotary joint |
| 33 | sliding means |
| 34 | sleeve |
| 38 | free end of 30 |
| 40 | actuating means |
| 42 | coupling element |
| 44 | linkage mechanism element |
| 45 | synchronizing means |
| 46 | synchronizing ring |
| 48 | rotary bearing |
| 49 | eccentric |
| 50 | interface |
| 60 | drive |
| 62 | lever |
| D | diameter |
| X | axis |

1. A machine door (2), comprising
a door frame (10) having an opening (20),
at least three door segments (30), and
an actuating means (40),
wherein the actuating means (40) can adjust the at least three door segments (30) from a position in the door frame (10) that clears the opening (20) to a position out of the door frame (10) that closes the opening (20).

2. The machine door (2) according to claim 1, characterized in that the actuating means (40) can adjust the at least three door segments (30) synchronously in a dipping movement.

3. The machine door (2) according to claim 2, characterized in that the at least three door segments (30) can emerge synchronously in the dipping movement from a recess (15) in the door frame (10) into the opening (20) and can retreat from the opening.

4. The machine door (2) according to claim 1, characterized in that the opening (20) in the door frame (10) is circular.

5. The machine door (2) according to claim 1, characterized in that the at least three door segments (30) are arranged circumferentially symmetrically around the opening (20).

6. The machine door (2) according to claim 1, characterized in that each door segment (30) is dagger-shaped.

7. The machine door (2) according to one of the preceding claims, claim 1, characterized in that the actuating means (40) comprises a synchronizing means (45) which can be rotated about the opening.

8. The machine door (2) according to claim 7, characterized in that the synchronizing means (45) is form-fittingly held by at least one rotary bearing (48).

9. The machine door (2) according to claim 1, characterized in that each door segment (30) is pivotally connected to the actuating means (40).

10. The machine door (2) according to claim 1, characterized in that each door segment (30) is connected to the door frame (10) in the manner of a coupler.

11. The machine door (2) according to claim 1, characterized in that each door segment (30) is connected to the door frame (10) via a linkage mechanism element (44).

12. The machine door (2) according to claim 1, characterized in that the actuating means (40) has a drive (60), in particular a linear drive.

13. The machine door (2) according to claim 1, characterized in that a sensor system is provided, in particular a sensor system for detecting the position in which the opening (20) is cleared and/or the position in which the opening (20) is closed by the at least three door segments (30).

14. A machine (1) having a process space and a machine door according to claim 1, which can close off the process space.
